(19) United States
(12) Patent Application Publication
(10) Pub. No.: US 2007/0273926 A1
(43) Pub. Date: Nov. 29, 2007

(54) Device and method for switching between image data objects

(75) Inventors: Keiji Sugiyama, Kyoto (JP); Kakuya Yamamoto, Hyogo (JP)

Correspondence Address: WENDEROTH, LIND & PONACK L.L.P., 2033 K. STREET, NW, SUITE 800, WASHINGTON, DC, 20006, US

(73) Assignee: Matsushita Electric Industrial Co., Ltd.

(21) Appl. No.: 11/802,354

(22) Filed: May 22, 2007

(30) Foreign Application Priority Data
May 25, 2006 (JP) 2006-145425

(51) Int. Cl. G06K 15/00

(52) U.S. Cl. 358/1.18

(57) ABSTRACT

An image controller is provided which comprises a switching unit configured to change image data objects on the screen of a monitor in the following steps. The switching unit first assigns priorities to image data objects for display on the screen. The switching unit next compares the priorities between a first image data object during display on the screen and a second image data object to be next displayed thereon, and determine a length of switching time depending on the result of comparison. The switching unit then changes each display form (i.e., size, position, format, display time, transparency, or level of layers) of the first and second image data objects on the screen continuously or stepwise during the switching time.

### BACKGROUND OF THE INVENTION

1. Field of the Invention

The present invention relates to an image controller and, in particular, a method for switching image data objects by using the image controller.

2. Background Information

Information (especially, image data) displayable on AV devices such as television receiver and portable electronic devices such as mobile phones and PDAs continues to increase in variety as the development of information technology in recent years. For example, television receivers can reproduce not only an increasing number of television broadcasting channels including digital broadcasting channels, but also the image data generated by applications such as operation screens and electronic program guides, and the image data provided from new information resources such as external recording media (e.g., DVDs and HDDs), home networks, and the Internet. Conversely, portable electronic devices can reproduce television broadcasting programs in addition to the image data generated by applications and the image data provided from mobile phone networks and the Internet.

As displayable image data objects increase in variety, the technology to select image data objects to be actually displayed from them increases in importance. Especially for portable electronic devices and wearable computers, it is desirable to switch between image data objects automatically and appropriately depending on situations.

For example, a following display controller is known as such a technology (cf., Japan Published Patent Application No. 2002-305695). The display controller is installed in a television receiver, and controls to switch its display from a television broadcasting program to another image data object as follows. The controller first compares priorities between the program during display and the image data object newly required to be displayed. The controller next determines the display size of the new image data object and the timing of actually switching the display from the program to the new image data object on the basis of the comparison result. Then, the controller will display the new image data object on a window separated from the window in which the program is displayed, in accordance with the determination. If the new image data object has a higher priority, e.g., if it is an urgent email, it will be immediately displayed in a display size larger than that of the program. On the other hand, if the new image data object has a lower priority, it will be delayed in a display size sufficiently smaller than that of the program, or after the program will end. Like this, the display form of the new image data object is adjusted depending on the difference in priority between the program during display and the new image data object. This aims to reduce viewer discomfort caused by the interruption of the new image data object.

Such a prior-art display controller suddenly and instantaneously switches from the screen including only the program to the screen including the new image data object in addition to the program. Accordingly, a viewer cannot recognize the importance of the new image data object at the instant when the screens are switched. As a result, it is difficult to sufficiently reduce the discomfort of the viewer caused by the instantaneous switching of the screens, even if the new image data object has a higher priority than the program during display. On the other hand, the instantaneous switching of the screens tends to provide a strong impression on the viewer even if the new image data object has a lower priority than the program during display, and even if the screens are changed a little before and after the switching. The strong impression also prevents the reduction of viewer discomfort. In particular, the viewer having a higher level of interest in the program feels the stronger discomfort.

In view of the above, it will be apparent to those skilled in the art from this disclosure that there exists a need for an improved image controller that can suppress the viewer discomfort caused by the switching between image data objects. This invention addresses this need in the art as well as other needs, which will become apparent to those skilled in the art from this disclosure.

### SUMMARY OF THE INVENTION

According to the present invention, an image controller is provided which comprises a switching unit configured to change image data objects on the screen of a monitor in the following steps. The switching unit first assigns priorities to image data objects for display on the screen. The switching unit next compares the priorities between a first image data object during display on the screen and a second image data object to be next displayed thereon, and determine a length of switching time depending on the result of comparison. The switching unit then changes each display form of the first image data object and the second image data object on the screen continuously or stepwise during the switching time. Here, the parameters indicating the display form of an image data object on the screen preferably include a size, a position, a format, display time per fixed length of time, transparency, or a level of layers thereof. In other words, each size, position, format, display time, transparency, or level of layers of the first and second image data objects are changed continuously or stepwise during the switching time. When each image data object includes audio data, each sound volume may be changed continuously or stepwise in parallel with the switching between the image data objects.

This image controller spends appropriate time (switching time) in switching between the image data objects, in contrast to a prior-art image controller that performs the switching instantaneously. This allows a viewer to notice the switching in advance. Furthermore, the image controller adjusts the switching time depending on the priories of the image data objects before and after the switching. Preferably, the higher priority the image data object to be newly displayed has, the shorter switching time is set, and accordingly, the switching is proceeding at a higher pace. Thus, a viewer can estimate the priority of the image data object to be newly displayed from the pace of the switching.

Here, the switching unit may be configured to change the parameters indicating the display form as a non-linear function of time. In this case, the change in length of the switching time can change an impression that a viewer will receive from the changing pattern of the display forms of image data objects, in addition to the pace of the switching therebetween. Thus, the viewer can also estimate the priority of the image data object to be newly displayed from the change of his/her impression.

The image controller preferably assigns priorities of image data objects by itself as follows.

When the image controller is installed in a portable electronic device (in particular, a wearable computer), the image controller preferably comprises a watching conditions acquisition unit. The watching conditions acquisition unit is configured to detect eyeball movements of a viewer preferably through an eye camera, and monitor the gaze conditions of the viewer on each of the image data objects displayed on the screen on the basis of the eyeball movements. In this case, the switching unit is preferably configured to assign priorities to the image data objects displayed on the screen on the basis of the gaze conditions that the watching conditions acquisition unit has acquired. More preferably, the watching conditions acquisition unit is configured to measure the gaze time or count the number of times that the viewer gazes on each of the image data objects displayed on the screen. In this case, the switching unit is preferably configured to assign a higher priority to the image data object when the watching conditions acquisition unit has measured the longer gaze time or counted the larger number of times of gazing thereon. The length of gaze time and the number of times of gazing on an image data object can be considered as the level of importance and interest that a viewer feels in the image data object. Accordingly, the switching unit can automatically assign higher priorities to the image data objects in which a viewer feels a higher level of importance or interest.

The image controller may comprise a watching history acquisition unit, which manages the history of image data objects that have displayed on the screen of the monitor. In this case, the switching unit assigns priorities to image data objects displayed on the screen of the monitor on the basis of the history managed by the watching history acquisition unit.

Preferably, the watching history acquisition unit classifies image data objects included in the history according to attributes, and the switching unit assigns higher priorities to image data objects having an attribute that a larger number of image data objects have in the history. Here, the types of attributes of image data objects include a title, a format (e.g., image, email, and music), a genre/category (e.g., movie, education, and news), and a type of information source (e.g., a name of a TV station and a transmitter of an email, and a URL). The attributes of image data objects are usually transmitted as auxiliary data objects together with the image data objects. The number of image data objects classified into each attribute in the history can be considered as the level of importance and interest that a viewer feels in the attribute. Accordingly, the switching unit can automatically assign higher priorities to the image data objects in which a viewer feels a higher level of importance or interest.

Alternatively, the watching history acquisition unit may classify image data objects included in the history according to their information sources, and the switching unit may assign higher priorities to image data objects having an attribute that a larger number of image data objects have in the history. Here, the types of sources of image data objects include a transmitter (e.g., a name of a TV station, a transmitter of an email, and a URL), a reproducing device (e.g., a player for DVD or next generation disc), and a type of a recoding medium (e.g., DVD and HDD). General image controllers can identify the sources of image data objects without decoding them from the attributions thereof. The number of image data objects classified into each source in the history can be considered as the level of importance and interest that a viewer feels in the attribute. Accordingly, the switching unit can automatically assign higher priorities to the image data objects in which a viewer feels a higher level of importance or interest.

The image controller may assign priorities to image data objects on the basis of the information entered from a viewer as follows. The image controller preferably comprises user profile management unit, which accepts information from a viewer. In this case, the switching unit assigns priorities to image data objects on the basis of the information from the viewer. The types of the information from the viewer preferably include the data object which shows an attribute or source of an image data object. The information from the viewer may be a data object for directly or indirectly assigning priorities to image data objects. In this case, viewers are allowed to freely assign priorities to image data objects according to attributes or sources in view of various types of standards, e.g., the levels of importance, interest, urgency, popularity, or safety.

As described above, the image controller performs the switching of image data objects continuously or stepwise in a finite length of the switching time. The image controller thereby allows a viewer notice the switching of image data objects in advance. Furthermore, the image controller changes the switching speed and the changing pattern in display form by adjusting the switching time depending on the priorities of image data objects, and thereby changes the impression that a viewer receives from the switching. The viewer can estimate the priority of the image data object to be newly displayed from the change of his/her impression. As a result, the viewer receives little discomfort from the switching of image data objects. Accordingly, a higher operability can be provided to an AV apparatus or a portable electronic device (in particular, wearable computer) equipped with the image controller than those equipped with a prior art image controller.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a portion of this original disclosure:

FIG. 1 is a block diagram of an image controller according to an embodiment of the present invention;

FIG. 2 shows a table of an example of auxiliary data objects stored in an image data storage unit shown in FIG. 1;

FIG. 3 shows priority tables managed by a priority table management unit shown in FIG. 1. Relationships between genres/categories/sources and importance levels of image data objects are arranged in the tables;

FIG. 4 shows a priority table managed by the priority table management unit shown in FIG. 1. Relationships between lengths of gaze time and interest levels of a viewer are arranged in the table;

FIG. 5 schematically shows an example of a camera included in a watching conditions acquisition unit shown in FIG. 1;

FIG. 6 shows a table in which the levels of importance and interest calculated by an importance level determination unit and an interest level determination unit, respectively, which are shown in FIG. 1;

FIG. 7 shows switching time tables generated by a switching method determination unit shown in FIG. 1. Relationships between levels of interest/importance and lengths of switching time are arranged in the tables;

FIG. 8 schematically shows the changes in display form, i.e., size, format, display time per segment in the switching time, and sound volume, of first and second image data objects in a switching time;

FIG. 9 shows a graph of a time change in size of the first image data object in a switching time caused by the switching method determination unit shown in FIG. 1;

FIG. 10 shows a table generated by the switching method determination unit shown in FIG. 1. Relationships between changing patterns and flags are arranged in the table; and

FIG. 11 is a flow chart of switching processes of image data objects by the image controller according to the embodiment of the present invention.

### DETAILED DESCRIPTION OF THE PREFERRED EMBODIMENT

A preferred embodiment of the present invention will now be explained with reference to the drawings. It will be apparent to those skilled in the art from this disclosure that the following descriptions of the embodiment of the present invention is provided for illustration only and not for the purpose of limiting the invention as defined by the appended claims and their equivalents.

According to a preferred embodiment, an image controller is preferably installed in a portable electronic device (in particular, mobile phone or wearable computer). Alternatively, the image controller may be installed in a television receiver or a personal computer. The image controller outputs image data objects provided from an external image data server to the monitor of the device equipped with the image controller, and thereby causes the monitor to display the image data objects on a screen. The image controller may be separated from an electronic device equipped with a monitor to be controlled. In particular, the image controller may be built in a single server, or constructed of a plurality of electronic devices and servers, and may control the display on a monitor of a user terminal through a network.

The image controller is preferably realized by software, in particular, by a predetermined program executed by a built-in computer of the portable electronic device and the like. Here, the program is preferably stored in a computer readable medium (e.g., a flexible disc, a next generation disc such as Blue-ray Disc, a hard disk, an MO, a CD, a DVD, or semiconductor memory), and invoked therefrom by a portable electronic device and the like. The program may be downloaded by the portable electronic device through a (wireless or wired) telecommunication network, in particular through a LAN, the Internet, or the like.

Alternatively, the image controller may be realized by hardware, i.e., by a semiconductor integrated circuit (IC, system LSI, super LSI, or ultra-LSI), a specific circuit, or a general-purpose processor. In particular, an FPGA (Field Programmable Gate Array) or a reconfigurable processor may be used in the image controller.

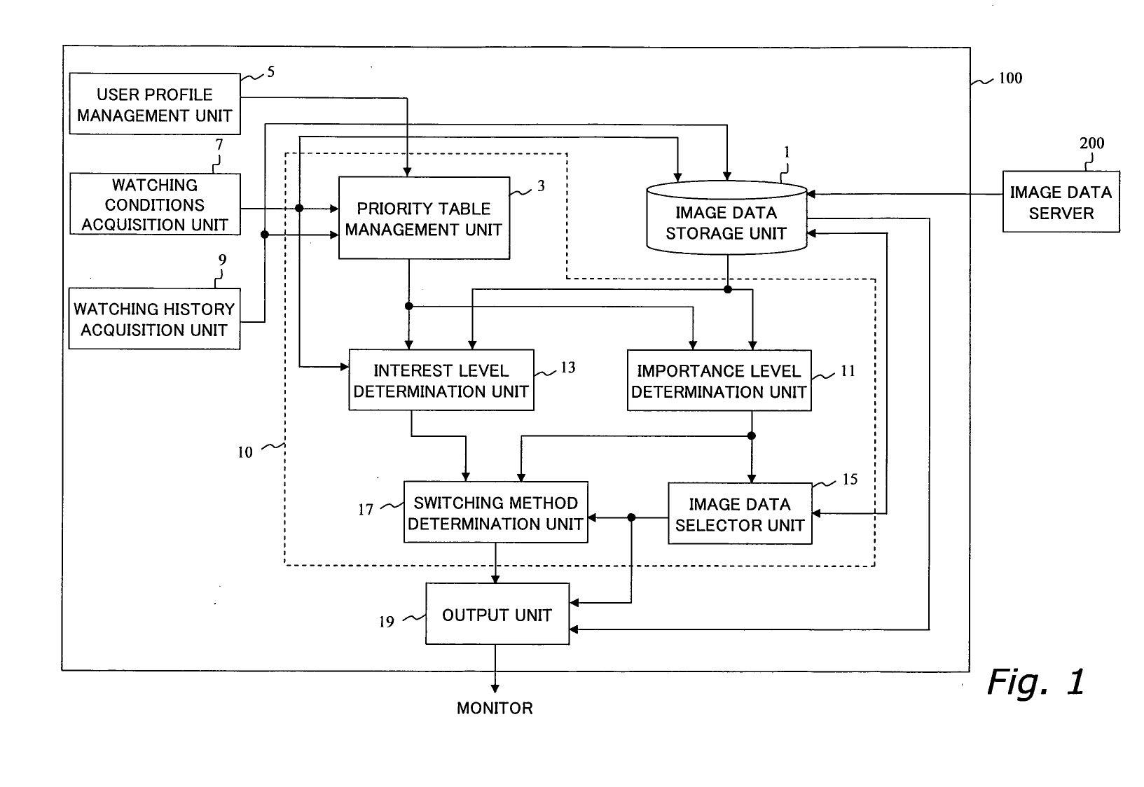

FIG. 1 shows a block diagram of the image controller. The image controller 100 comprises an image data storage unit 1, a user profile management unit 5, a watching conditions acquisition unit 7, a watching history acquisition unit 9, a switching unit 10, and an output unit 19.

An explanation about each component of the image controller 100 will be described below in order.

The image data storage unit 1 preferably includes a receiver unit such as a tuner and a recorder unit such as a HDD, and acquires and stores image data objects from an external image data server 200. Here, the types of the image data servers 200 preferably include a TV station or a server on a network (a LAN or the Internet). The types of image data objects provided from the image data server 200 to the image controller 100 preferably include a TV broadcasting program, text and HTML (HyperText Markup Language) data (e.g., web pages and emails), and data streams in multimedia formats that consist of video and sound. When the image data storage unit 1 acquires image data objects from a network server, it preferably uses an email protocol such as POP3/IMP (Post Office Protocol 3 and Interface Message Processor), HTTP (HyperText Transfer Protocol), HTTPS (Hypertext Transfer Protocol Security), and RTP (Real time Transport Protocol).

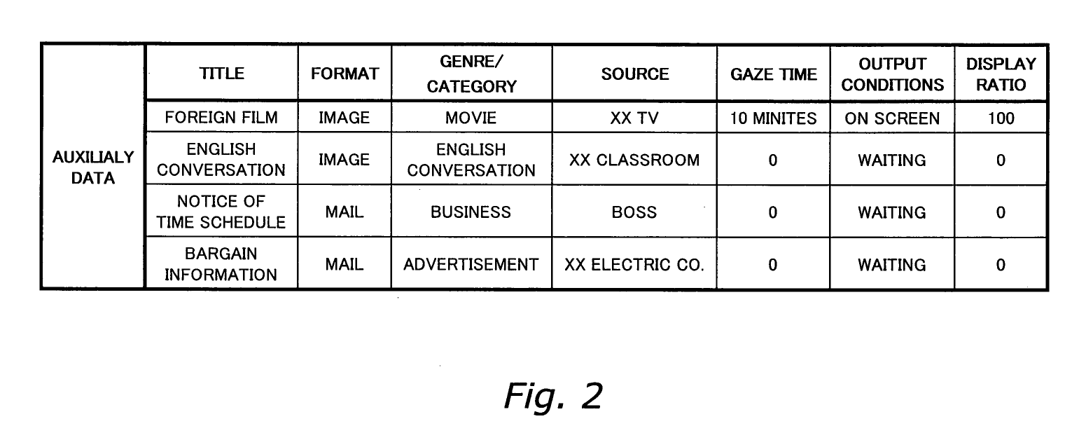

The image data storage unit 1 preferably acquires and stores not only image data objects but also auxiliary data objects thereabout. Auxiliary data objects preferably include meta-data. Meta-data are preferably described in MPEG7 or RDF (Resource Description Framework). Auxiliary data objects preferably include subtitles, attributes of image data objects, and information related to conditions of watching image data objects. Here, attributes of image data objects include a title, a format (e.g., image, email, and music), a genre/category (e.g., movie, education, and news), and a type of information source (e.g., a name of a TV station and a transmitter of an email, and a URL). Information related to conditions of watching image data objects includes a time length or a number of times that a viewer gazes on each image data object, conditions of each image data object outputted to the monitor, and data showing a display form of each image data object on the screen of the monitor (e.g., the size ratio of the image data object with respect to the entire screen, or a display ratio thereof). The information is used by the watching conditions acquisition unit 7 and the watching history acquisition unit 9 as described bellow. FIG. 2 shows an example of auxiliary data objects stored in the image data storage unit 1. A title, a format, a type, a transmitter name, gaze time, an output condition, and a display ratio of each image data object are listed in each record of auxiliary data objects.

The user profile management unit 5 preferably manages a user profile that a viewer has entered therein in advance. The user profile preferably includes the viewer's sex, age, hobby, taste, and occupation. The user profile management unit 5 more preferably manages the user profiles of more than one user to which predetermined user IDs are assigned. The users, for example, include not only the user in possession of the electronic device including the monitor to be controlled, but also his/her family. In that case, the user profile management unit 5 preferably acquires a user ID from a user on or before he/she will use the electronic device in order to watch image data objects, and then sends the user profile linked to the user ID to the switching unit 10 (in particular, a priority table management unit 3).

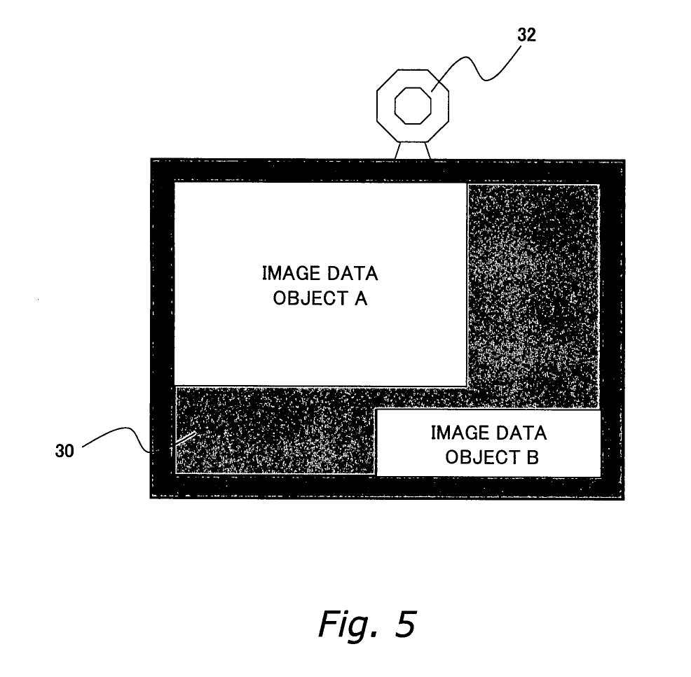

The watching conditions acquisition unit 7 detects watching conditions on each image data objects displayed on the screen of the monitor, and transmits the detected watching conditions to the switching unit 10. Watching conditions preferably include the information indicating whether or not a viewer is watching the image data object at the present time, and how long a viewer is watching the image data object displayed at the present time. The watching conditions acquisition unit 7 preferably includes a camera. FIG. 5 shows an example of the camera. The camera 32 is mounted on the frame of the monitor 30 as shown in FIG. 5. The watching conditions acquisition unit 7 detects the position and posture of a viewer through the camera 32. On the basis of the detected result, the watching conditions acquisition unit 7 further determines whether or not the viewer is watching the image data object at the present time, or measures the time length that the viewer continues to watch the image data object. The camera 32 is more preferably an eye camera. In that case, the watching conditions acquisition unit 7 detects the viewer's eyeball movement through the eye camera 32. On the basis of the detected eyeball movement, the watching conditions acquisition unit 7 further monitors the gaze conditions of the viewer on each image data object displayed on the screen of the monitor 30. More specifically, the watching conditions acquisition unit 7 first detects which position on the screen the viewer is gazing at, and then judges that the viewer is watching the image data object displayed at the detected position at the present time. The watching conditions acquisition unit 7 repeats such a judgment at regular intervals or each time a gaze position moves beyond a predetermined limit. The watching conditions acquisition unit 7 thus measures the time length or the number of times that the viewer gazes on each image data object during display (within a predetermined time length or for each title). The watching conditions thus measured are transmitted from the watching conditions acquisition unit 7 to the switching unit 10 (in particular, the priority table management unit 3 and the interest level determination unit 13) and the image data storage unit 1 consecutively, at regular intervals, or each time a change in watching conditions is detected. The image data storage unit 1 then stores the watching conditions (in particular, gaze time) received from the watching conditions acquisition unit 7 as auxiliary data objects about individual image data object (cf. FIG. 2).

The watching history acquisition unit 9 monitors conditions of each image data object outputted to the monitor, and a display form (in particular, a display ratio) of each image data object on the screen of the monitor. The conditions and display form are transmitted from the watching history acquisition unit 9 to the image data storage unit 1 consecutively, at regular intervals, or each time a change in the conditions or the display form is detected. The image data storage unit 1 then stores the conditions and the display form (in particular, the display ratio) received from the watching history acquisition unit 9 as auxiliary data objects about individual image data object (cf. FIG. 2).

The watching history acquisition unit 9 also manages the history of image data objects that have been displayed on the screen of the monitor 30. The watching history acquisition unit 9 preferably classifies image data objects included in the history according to attributes or information sources. Here, the types of sources of image data objects include a transmitter (e.g., a name of a TV station, a transmitter of an email, and a URL), a reproducing device (e.g., a player for DVD or next generation disc), and a type of a recoding medium (e.g., DVD and HDD). The watching history acquisition unit 9 can usually identify the source of each image data object without decoding it from the attributions thereof. The watching history acquisition unit 9 preferably updates the history and sends it to the switching unit 10 (in particular, the priority table management unit 3) each time image data objects are switched on the screen of the monitor 30.

The switching unit 10 assigns priorities to image data objects for display on the screen of the monitor 30 on the basis of data acquired from the user profile management unit 5, the watching conditions acquisition unit 7, and the watching history acquisition unit 9. The switching unit 10 further manages the outputs of image data objects from the image data storage unit 1 to the output unit 19. In particular, when the image data storage unit 1 requires the switching unit 10 to display a new second image data object on the screen of the monitor 30 during the display of a first image data object on the screen, the switching unit 10 first compares the priorities between the first and second image data objects, and determines a length of switching time depending on the result of comparison. The switching unit 10 then instructs the output unit 19 how to switch between the image data objects, i.e., how to change each display form of the image data objects on the screen during the switching time.

The output unit 19 controls the monitor, and outputs image data objects received from the image data storage unit 1. In particular, the output unit 19 changes the display forms of the first image data object during display on the screen of the monitor 30 and the second image data object to be newly displayed thereon continuously or stepwise during the switching time.

Details of the switching unit 10 will be described as follows.

Referring to FIG. 1, the switching unit 10 preferably includes a priority table management unit 3, an importance level determination unit 11, an interest level determination unit 13, an image data selector unit 15, and a switching method determination unit 17.

The priority table management unit 3 manages priority tables. In each priority table, relationships between image data objects and their priorities are arranged preferably in accordance with auxiliary data objects about image data objects. The priority tables are preferably updated on the basis of data received from the user profile management unit 5, the watching conditions acquisition unit 7, and the watching history acquisition unit 9. The priority tables will be used in the determination of the method of switching between image data objects (details will be described below).

Preferably, levels of importance and interest are assigned to image data objects as their priorities. More preferably, the levels of importance and interest are automatically assigned on the basis of user profiles of a viewer, the watching conditions of a viewer on each image data object, and the history of image data objects that have been displayed on the screen of the monitor 30, as follows.

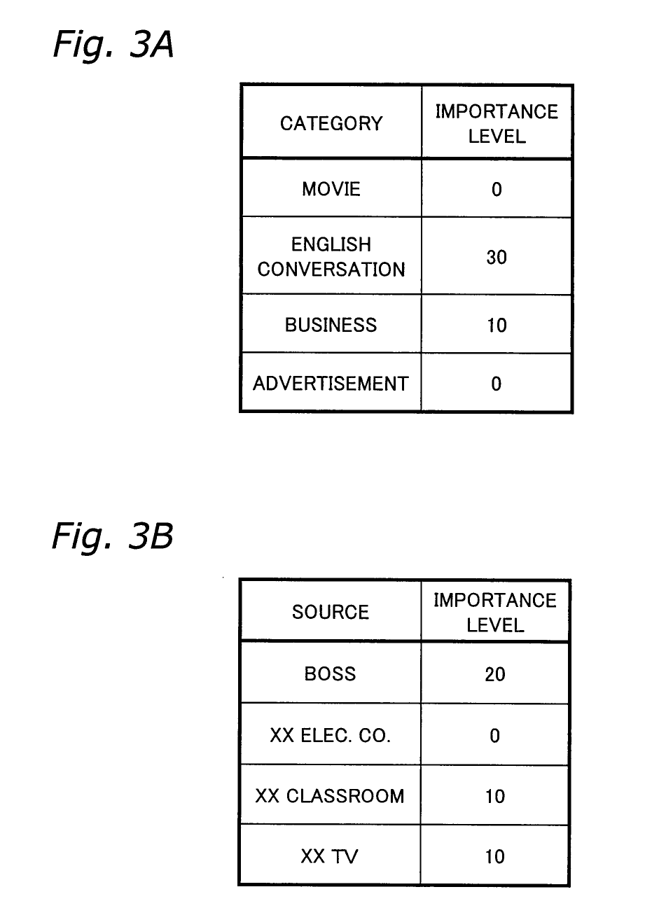

FIG. 3A shows an example of the priority table. Relationships between genres/categories and importance levels of image data objects are arranged in this priority table. FIG. 3B shows another example of the priority table. Relationships between information sources and importance levels of image data objects are arranged in this priority table.

For example, the priority table management unit 3 assigns a category “business” to the genre/category of image data objects that relates to the viewer's occupation, on the basis of the viewer's user profile. It can be generally assumed that a higher level of importance is to be assigned to the image data objects belonging to the category “business”. Accordingly, a higher level of importance is assigned to the image data objects belonging to the category “business” in the priority table, as shown in FIG. 3A. The priority table management unit 3 may assign a higher level of importance to the image data objects of the types that are suitable for the viewer's taste. In the priority table, higher levels of importance or interest are thus assigned to the image data objects of the types to which higher levels of importance or interest are generally to be assigned in view of items of the viewer's user profile, i.e., higher priorities can be automatically assigned to those image data objects.

When the watching history acquisition unit 9 classifies image data objects included in the history in accordance with their attributes, the priority table management unit 3 preferably assigns higher priorities to image data objects having the attributes that a larger number of image data objects in the history have. For example, a larger number of image data objects are classified in a category “English conversation” in the history managed by the watching history acquisition unit 9 when a specific user causes the monitor to frequently display the image data objects belonging to the category “English conversation”. In the priority table, a higher level of importance is accordingly assigned to the image data objects belonging to the category “English conversation” as shown in FIG. 3A.

When the watching history acquisition unit 9 classifies image data objects included in the history in accordance with their sources, the priority table management unit 3 preferably assigns higher priorities to image data objects from the sources that originate a larger number of image data objects in the history. For example, a larger number of image data objects are classified in the source “boss” or “customer” in the history managed by the watching history acquisition unit 9 when a specific user causes the monitor to frequently display the image data objects received from his/her boss or customers. In the priority table, higher levels of importance are accordingly assigned to the image data objects received from the boss and the customers as shown in FIG. 3B.

The number of image data objects that have each attribute or have been received from each source in the history can be considered to indicate the level of importance or interest of the viewer in the attribute or the source, respectively. Accordingly, higher priorities can be automatically assigned to the image data objects on which the viewer places higher levels of importance or interest. Note that the priority table management unit 3 may further use a neural network or a Bayesian network to learn the setting of the priority tables from the history of image data objects (when image data objects are emails, the history may be records of transmission and reception), and may optimize the priority tables at any time. The priority table management unit 3 can thereby improve the accuracy of estimating priorities based on the history of image data objects.

The priority table management unit 3 may alternatively assign priorities to image data objects of each type or from each source on the basis of schedules or task lists of users held by a server or a portable electronic device. In particular, the priority table management unit 3 may temporally change the priority of each image data object in accordance with the schedule. For example, the importance level of image data objects belonging to the category “business” may be higher and lower on weekdays and holidays, respectively.

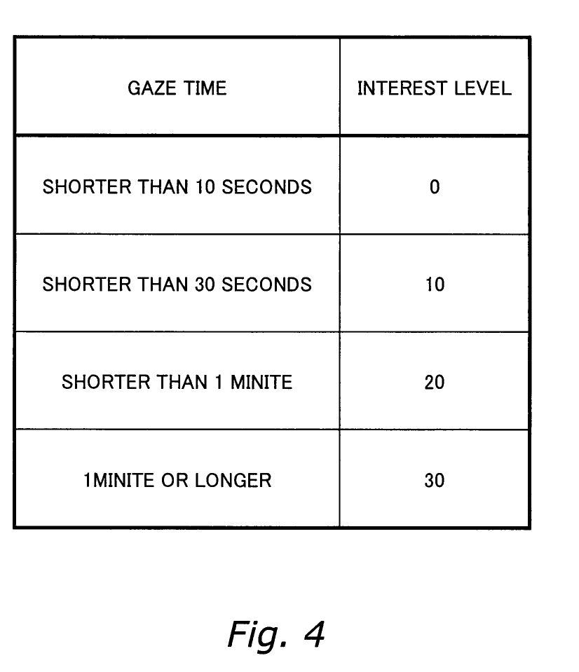

FIG. 4 shows another example of the priority table. Relationships between lengths of gaze time and interest levels of a viewer are arranged in this priority table. As shown in FIG. 4, the priority table management unit 3 assigns higher levels of interest (i.e., priorities) to image data objects on which longer gaze time is recorded. The time and number of times that a viewer gazes on each image data object can be considered to indicate the level of importance or interest that the viewer places on the image data object. Accordingly, the priority table management unit 3 can automatically assign higher priorities to image data objects on which the viewer places higher levels of importance or interest.

Note that an actual interest level on each image data object generally varies from viewer to viewer even if the same gaze time or the same number of times of gazing is recorded on the image data object. Accordingly, the priority table management unit 3 preferably uses different relationships between interest levels and lengths of gaze time (or, the numbers of times of gazing) for different viewers. In other words, different priority tables as shown in FIG. 4 are prepared for different users registered in the user profile management unit 5. Furthermore, the priority tables are updated each time the watching conditions acquisition unit 7 has detected a change in the viewer's watching conditions.

Levels of importance or interest may be assigned to image data objects by a viewer directly or indirectly through the user profile management unit 5, in contrast to the above-described automatic assignment. In that case, the viewer can assign levels of importance or interest to image data objects according to general values, relevance to the viewer's occupation, the viewer's taste, and the like. Furthermore, levels of urgency, popularity, or safety can be used as priorities. Here, the level of urgency indicates how urgent an image data object is to be provided to a viewer. The level of popularity indicates the level of interest that a viewer or the general public places on an image data object. The level of safety indicates the ratio of harmful information (e.g., adult and violence information) included in an image data object. A viewer may freely assign priorities to image data objects having each attribute or received from each source in accordance with various standards.

The importance level determination unit 11 uses the priority tables to determine levels of importance to be placed on each image data object that is stored in the image data storage unit 1. Preferably, titles, formats, genres/categories, and sources included in the auxiliary data objects shown in FIG. 2 are used to determine importance levels.

Details how to determine importance levels will be described bellow, by taking a case where the determination is based on genres/categories and sources of image data objects as an example.

(i) Determination of Importance Levels Based on Types of Image Data Objects

Importance levels are assigned to genres/categories of image data objects in the priority table shown in FIG. 3A. The importance level determination unit 11 uses the priority table of FIG. 3A to determine levels of importance to be placed on each image data object that is stored in the image data storage unit 1. In FIG. 2 for example, an importance level “0” is assigned to an image data object of a title “foreign film”, since it is classified as a category “movie”. Similarly, importance levels “30”, “10”, and “0” are respectively assigned to image data objects of titles “English conversation”, “notice of time schedule”, and “bargain information”.

(ii) Determination of Importance Levels Based on Sources of Image Data Objects

Sources of image data objects are preferably represented by names of persons/organizations or the identifier of devices that have transmitted the image data objects. For example, when an image data object is a TV program, its source is generally a name of a TV station. When an image data object is email, its source is a name of a transmitter shown in the “From” header of the email. When an image data object is included in a web page, its source is the URL of the site including the web page.

Importance levels are assigned to sources of image data objects in the priority table shown in FIG. 3B. The importance level determination unit 11 uses the priority table of FIG. 3B to determine levels of importance to be placed on each image data object that is stored in the image data storage unit 1. In FIG. 2 for example, an importance level “10” is assigned to an image data object of a title “foreign film”, since its source is the name of a TV station “XX TV”. Similarly, importance levels “10”, “20”, and “0” are respectively assigned to image data objects of titles “English conversation”, “notice of time schedule”, and “bargain information”.

(iii) Total of Importance Levels

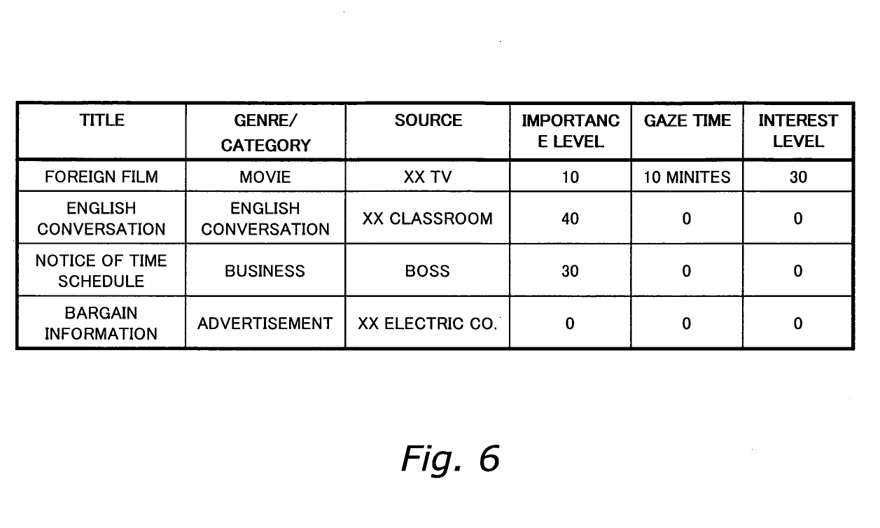

The importance level determination unit 11 preferably determines two types of importance levels of each image data object in the above-described manners (i) and (ii), and then calculates the total of the importance levels as an importance level of the image data object. Importance levels that have been calculated in such a manner are listed in the table shown in FIG. 6. The highest level of importance is assigned to the image data object of the title “English conversation” in the example shown in FIG. 6. The importance determination unit 11 outputs importance levels thus determined to the switching method determination unit 17 and the image data selector unit 15.

The interest level determination unit 13 uses the priority table of FIG. 4 to determine levels of interest to be placed on each image data object that is stored in the image data storage unit 1. Preferably, gaze time included in the auxiliary data objects shown in FIG. 2 is used to determine interest levels. In FIG. 2 for example, an interest level “30” is assigned to an image data object of a title “foreign film”, since the gaze time thereon has a length of “10 minutes”. Similarly, the same interest level “0” is assigned to image data objects of titles “English conversation”, “notice of time schedule”, and “bargain information”. The interest level determination unit 13 outputs interest levels thus determined to the switching method determination unit 17.

The image data selector unit 15 first uses the importance level of each image data object calculated by the importance level determination unit 11 to determine whether or not to replace an image data object being outputted from the output unit 19 to the monitor at the present time with another image data object”. Here, the image data selector unit 15 may perform the determination at regular intervals, each time importance levels of image data objects are updated, or each time an interruption of a new image data object is required from the image data storage unit 1. When having determined that the switching of image data objects is necessary, the image data selector unit 15 then selects the image data object being outputted from the output unit 19 to the monitor at the present time as an object to be replaced, and retrieves an image data object, which is to be newly outputted in place of the object to be replaced, from the image data storage unit 1.

First, the image data selector unit 15 preferably retrieves image data objects having higher levels of importance than the image data object being outputted from the output unit 19 to the monitor at the present time from image data objects waiting for display in the image data storage unit 1. If having retrieved such image data objects, the image data object selection unit 15 determines that the switching of image data objects is necessary, and selects the image data object having the highest level of importance from the retrieved image data objects as a new object to be outputted. More specifically, the image data selector unit 15 first accesses the image data storage unit 1, and checks output conditions included in auxiliary data objects of each image data object. In FIG. 2 for example, the image data object of the title “foreign film” is being outputted from the output unit 19 to the monitor at the present time, while other image data objects are waiting for output. The image data selector unit 15 next uses the importance levels received from the importance level determination unit 11 to compare importance levels between the image data object of the title “foreign film” and other image data objects. In FIG. 6 for example, the importance level of “10” is assigned to the image data object of the title “foreign film”. On the other hand, a higher level of importance “40” is assigned to the image data object of the title “English conversation” than any other image data objects waiting for output as well as the image data object of the title “foreign film”. Accordingly, the image data object selection unit 15 determines that the switching of image data objects is necessary, selects the image data object of the title “foreign film” as an object to be replaced, and selects the image data object of the title “English conversation” as an object to be newly outputted.

The image data selector unit 15 then provides the output unit 19 with data to be used to identify the image data objects to be replaced and to be newly outputted. Note that more than one image data objects may be selected as each image data object to be replaced or newly outputted, when the output unit 19 can display a plurality of image data objects in multi-windows on the same screen of the monitor.

The switching method determination unit 17 determines how to switch from an image data object to be replaced (hereinafter, a first image data object) to an image data object to be newly outputted (hereinafter, a second image data object). Preferably, the method to switching from the first image data object to the second image data object is determined by switching time Δt and a changing pattern in display form of each image data object within the switching time Δt (hereafter, a switching type). Here, a size, a position, a format, a display time rate, transparency, and a level of a layer on the screen of the monitor, and sound volume are used as parameters indicating display forms (hereinafter, display parameters).

(i) Switching Time Δt

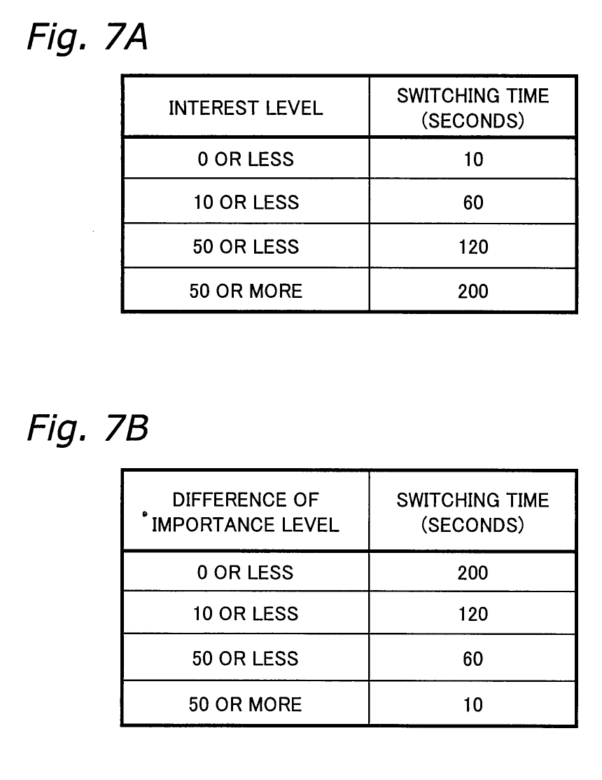

The switching method determination unit 17 calculates switching time Δt on the basis of the importance and interest levels assigned to each of the first and second image data objects in the following steps (a)-(c). The switching method determination unit 17 prepares a switching time table for each of interest and importance levels in advance. Relationships between interest levels and lengths of switching time Δt are arranged in the switching time table of FIG. 7A. Different lengths of switching time Δt are assigned to differences in importance level between first and second image data objects in the switching time table of FIG. 7B.

(a) Determination of Switching Time Δt Based on Interest Level

The switching method determination unit 17 first determines the length of switching time Δt based on the interest level of the first image data object. According to FIG. 6, an interest level “30” is assigned to the first image data object (of the title “foreign film”). Accordingly, the switching method determination unit 17 calculates that the length of switching time Δt is 120 seconds in view of the switching time table of FIG. 7A.

A viewer with a higher level of interest in the first image data object could feel stronger discomfort if the first image data object were suddenly switched to the second image data object. However, a higher level of interest has been assigned to the first image data object on which longer gaze time has been recorded, since it can be assumed that the first image data object attracts keen interest from the viewer. Moreover, the higher interest level of the first image data object causes switching time Δt to be longer. The longer switching time Δt is then spent in switching from the first image data object to the second image data object as described bellow. This can reduce the viewer's discomfort received from the switching.

(b) Determination of Switching Time Δt Based on Importance Level

The switching method determination unit 17 next calculates a difference in importance level between the first and second image data objects, and uses it to determine the length of switching time Δt. According to FIG. 6, importance level “10” and “40” are assigned to the first image data object (of the title “foreign film”), and the second image data object (of the title “English conversation”), respectively. Accordingly, the difference in importance level therebetween is “30”. The switching method determination unit 17 then calculates that the length of switching time Δt is 60 seconds in view of the switching time table of FIG. 7B.

The first image data object should be changed to the second image data object at a faster pace when the higher level of importance is placed on the second image data object than the first image data object. In the above embodiment, a larger difference in importance level has been assigned between the first and second image data objects when it can be assumed that the second image data object is more important for the viewer than first image data object. Moreover, the larger difference in importance level causes switching time Δt to be shorter. The shorter switching time Δt is then spent in switching from the first image data object to the second image data object as described bellow. This faster pace of the switching can help the viewer easily recognize the higher importance level of the second image data object. This can reduce the viewer's discomfort received from the switching.

(c) Determination of Final Switching Time by Averaging

The switching method determination unit 17 then takes the average of both the switching time Δt=120 seconds and Δt=60 seconds, which has been calculated in (a) and (b) by using interest and importance levels, respectively. The switching method determination unit 17 thereby determines that the final switching time Δt is the average, 90 seconds.

Note that, like the step (a), the step (b) may determine switching time Δt based on the relationships between importance levels of individual image data objects and lengths of switching time Δt, instead of a difference in importance level between the first and second image data objects. In addition, the step (c) may select either switching time calculated from interest and importance levels as final switching time Δt, instead of the average thereof.

For example, the levels of urgency, popularity, or safety may be used as priorities, instead of the above-described levels of importance and interest. More specifically, the levels of urgency, popularity, or safety are in advance assigned to image data objects stored in the image data storage unit 1, and the levels are compared between the first and second image data objects in a similar manner. Then, switching time is determined from the difference in level of urgency, popularity, or safety between the first and second image data objects. For example, the difference in urgency level is increased when a higher urgency level is assigned to the first image data object than the second image data object. In that case, switching time Δt is reduced as described above. As a result, the image controller can immediately provide a viewer with an image data object on which a higher urgency is to be placed, regardless of importance or interest levels placed on the image data object that the viewer is watching.

Note that a constant length of switching time Δt may be determined when each priority of the first and second image data objects or a difference in priority therebetween falls within a predetermined range. In that case, each display form of the image data objects that is changed continuously or stepwise within the switching time Δt can reduce discomfort that a viewer receives from the switching.

The types of switching from the first image data object to the second image data object preferably include the following types (ii)-(v).

(ii) Change in Display Size

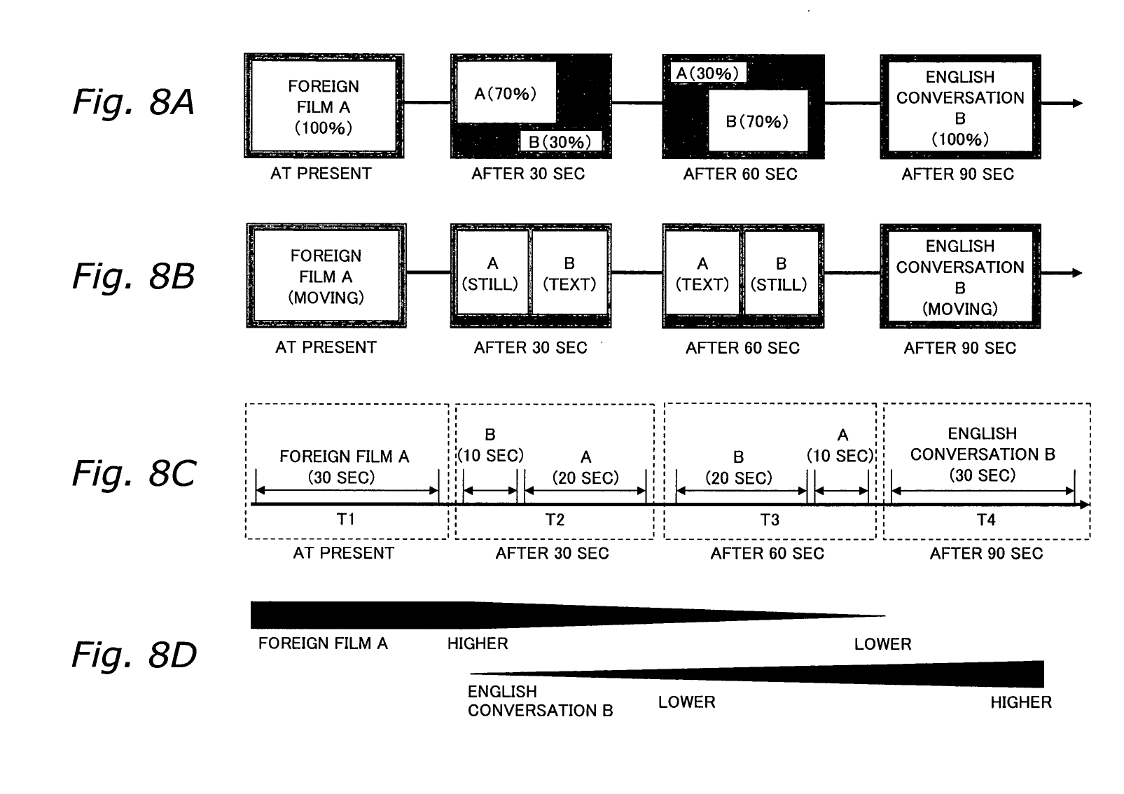

The switching method determination unit 17 may change each display size of the first and second image data objects continuously or stepwise, depending on elapsed time within the switching time Δt as follows. FIG. 8A shows changes in display size of the first image data object A and the second image data object B within the switching time Δt. As shown in FIG. 8A, the display size of the first image data object (of the title “foreign film”) A is reduced stepwise, e.g., 100%, 70%, 30%, and 0%, every 30 seconds within the final switching time Δt=90 seconds. Conversely, the display size of the second image data object (of the title “English conversation”) B is increased stepwise, e.g., 0%, 30%, 70%, and 100%. Thus, the screen display on the monitor is switched from the first image data object A to the second image data object B stepwise throughout the entire switching time Δt=90 seconds. This enables a viewer to shift his/her interest to the second image data object B gradually while watching the first image data object A. Thus, the viewer can receive less discomfort from the switching from the first image data object to the second image data object.

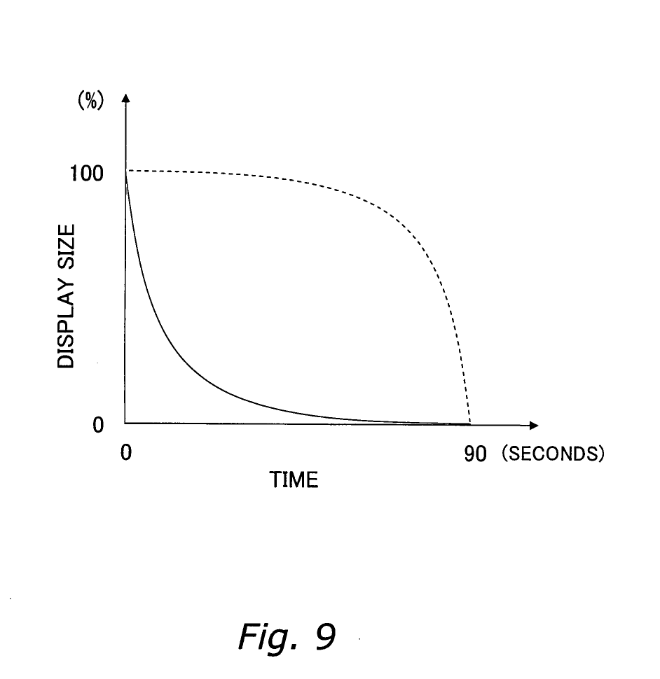

Preferably, the changes in display size of image data objects within switching time Δt is expressed in advance by using a function of time in the switching method determination unit 17. In other words, the switching method determination unit 17 uses the function to calculate changes in display size from given switching time Δt. Here, the function may be a linear function. Preferably, the function is a non-linear function such as a function expressed by a solid or broken line shown in FIG. 9. When the function expressed by the solid line is used, a display size is rapidly reduced in the early stages of switching time, and then gradually reduced in the following stages. When the function expressed by the broken line is used, a display size is gradually reduced in the first half of the switching time, and rapidly reduced in the latter half thereof. The functions may be empirically or experimentally determined. In addition, the form of the function (e.g., the curved shapes of the solid and broken lines in FIG. 9, and the above-described steps 0%, 30%, 70%, and 100%) may be fixed regardless of importance and interest levels, or changed depending thereon. For example, a display size may be more steeply changed, e.g., 0%, 50%, 90%, 100%, with increases in levels of importance and interest. In particular when a higher level of importance is assigned to the second image data object than the first image data object, the display size of the second image data object is fully increased in the early stages of the switching time Δt. This enables the second image data object to attract a viewer. Alternatively, a display size may be changed stepwise at finer intervals, e.g., 0%, 10%, 20%, . . . , 100% every 10 seconds within switching time. The length of each interval may be changed depending on levels of importance and interest.

(iii) Change in Format

The switching method determination unit 17 may change each format of the first and second image data objects continuously or stepwise, depending on elapsed time within the switching time Δt as follows. FIG. 8B shows changes in format of the first image data object A and the second image data object B within the switching time Δt. As shown in FIG. 8B, the format of the first image data object (of the title “foreign film”) A is changed in the order of moving image, still image, and subtitles (text data) every 30 seconds within the final switching time Δt=90 seconds. This format change is equivalent to the stepwise reduction in data amount of the first image data object A displayed on the screen. On the other hand, the format of the second image data object (of the title “English conversation”) B is changed in the order of text, still image, and moving image, so that the data amount of the second image data object is stepwise increased. This allows a viewer to receive the gradually increasing amount of data from the second image data object B within the switching time Δt while watching the first image data object A. Thus, the viewer receives less discomfort from the switching from the first image data object to the second image data object.

Formats may be changed in only two steps of still and moving image (or, other combinations) instead of the change in three steps of text, still image, and moving image. Furthermore, the number in steps and combination may be changed depending on levels of importance and interest. In addition, levels of definition may be continuously or stepwise changed for the same moving image. Alternatively, a format may be stepwise changed at finer intervals. The intervals may be changed depending to levels of importance and interest. In contrast to FIG. 8B for example, when a sufficiently higher level of importance is assigned to the second image data object than the first image data object, the second image data object may be displayed in text when 20 seconds has elapsed from the start of the switching time, and in still image when 40 seconds has elapsed from the start. This causes the second image data object to appear in the format with larger data amount in the early stages of switching time Δt, and thereby enables the second image data object to attract a viewer. Note that a format may be changed only for the second image data object, instead of both the first and second image data objects.

(iv) Change in Display Time Rate

The switching method determination unit 17 divides switching time Δt into segments of a predetermined time length, and changes each display time rate of the first and second image data objects (which indicates a ratio of a display time per segment with respect to the entire length of a segment) segment by segment. FIG. 8C shows display time of the first image data object A and the second image data object B in segments T1, T2, T3, and T4 of switching time Δt. The lengths of the segments are uniformly 30 seconds as shown in FIG. 8C. The display time of the first image data object (of the title “foreign film”) A per segment is stepwise reduced, e.g., 30 seconds, 20 seconds, 10 seconds, and 0 seconds in the order of starting from the first segment T1. On the other hand, the display time of the second image data object (of the title “English conversation”) B per segment is stepwise increased, e.g., 10 seconds, 20 seconds, and 30 seconds in the order starting from the segment T1. This allows a viewer to gradually shift his/her interest to the second image data object B while watching the first image data object A. Thus, the viewer receives less discomfort from the switching from the first image data object to the second image data object.

An increment/decrement of display time per segment may be changed within switching time Δt, instead of a fixed increment/decrement, e.g., 10 seconds described above. For example, the display time of the first image data object may be reduced in the order of 30 seconds, 15 seconds, 5 seconds, and 0 seconds, and the display time of the second image data object may be increased in the order of 0 seconds, 15 seconds, 25 seconds, and 30 seconds. In addition, display time may be changed depending on levels of importance and interest. For example, when a sufficiently higher level of importance is assigned to the second image data object than the first image data object, the display time of the second image data object may be increased in the second segment T2 or the third segment T3. This enables the second image data object to attract a viewer in the early stages of the switching time Δt. Alternatively, the lengths of segments may be changed depending on levels of importance and interest, instead of a fixed length, e.g., 30 seconds. Note that FIG. 8C can be consider as showing the case where the display size of each image data object is switched between two values, 0% and 100%, as follows. For example, the display size of the second image data object B is 0% in the first segment T1, 0% in early 10 seconds of the second segment T2, and 100% in remaining 20 seconds thereof.

In FIGS. 8A, 8B, and 8C, the second image data object B is spatially and temporally separated from the first image data object A on the screen. Alternatively, the second image data object B may be overlapped with the first image data object A on the screen. In that case preferably, transparency of each image data object is continuously or stepwise changed within switching time Δt. For example, the second image data object is faintly displayed over the first image data object in the first half of the switching time, and the reverse is in the latter half thereof. Alternatively, the display layers of the image data objects may be continuously or stepwise changed in levels within switching time Δt. This may repeat reversing the order of the two display layers within switching time, and furthermore, the time one display layer is maintained on the other may be continuously or stepwise changed. For example, the time the first image data object is displayed on the second image data object is longer and shorter in the first and latter halves of switching time, respectively.

(v) Change in Sound Volume

When audio data is appended to the first and second image data objects, the switching method determination unit 17 may continuously or stepwise change sound volumes of the reproduced audio data depending on elapsed time within switching time Δt, in parallel with the switching of the first and second image data objects by the method (i)-(iv). FIG. 8D shows sound volumes of audio data reproduced in parallel with the switching of the first image data object A and the second image data object B within switching time Δt. As shown in FIG. 8D, the sound volume reproduced in parallel with the display of the first image data object (of the title “foreign film”) A is stepwise reduced, while the sound volume reproduced in parallel with the display of the second image data object (of the title “English conversation”) B is stepwise increased. Note that the rate of changes in sound volume may be changed depending on levels of importance and interest.

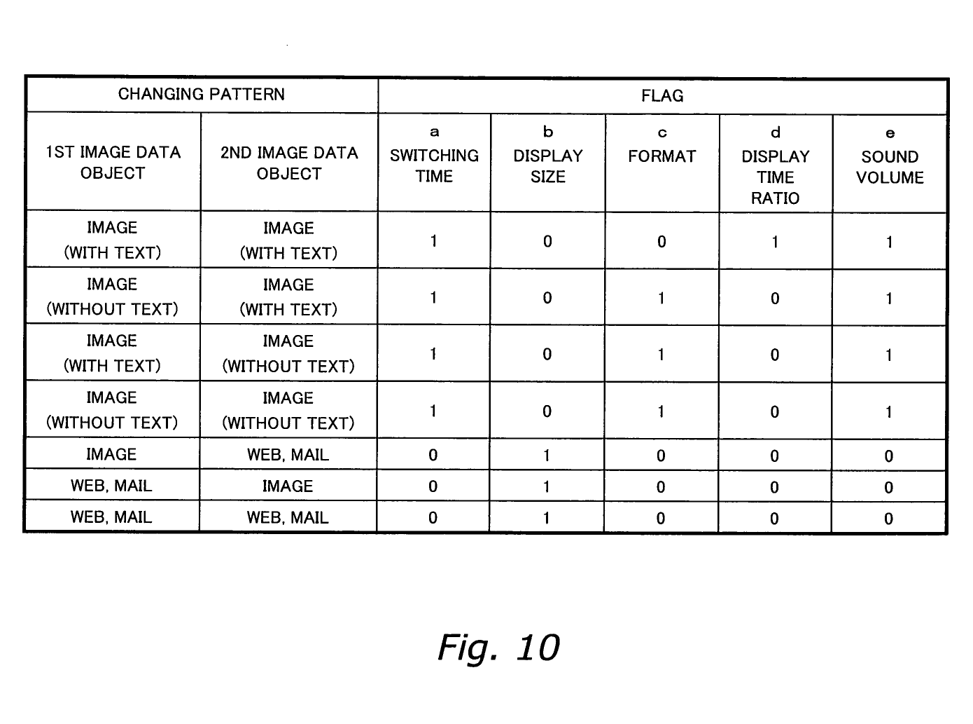

The switching method determination unit 17 selects the type of switching from the first image data object to the second image data object from the above-described methods (ii)-(v) as follows. FIG. 10 shows relationships between changing patterns and flags. Here, changing patterns are referred to as combinations in format of the first and second image data objects, and flags are referred as flags indicating that individual types of switching are selected or non-selected. In FIG. 10 for example, the first flag a indicates whether or not to vary lengths of switching time Δt with image data objects. When the first flag a indicates “1”, the lengths of switching time Δt are varied with image data objects. When the first flag indicates “0”, the length of switching time Δt is fixed at a predetermined value for every image data object. Similarly, the values “1” and “0” of the second flag b through the fifth flag e indicate whether or not to change in display size, format, display time rate, and sound volume.

Details of a changing pattern shown on the first raw of the table in FIG. 10 will be described bellow. In the changing pattern, the first image data object classified as a format “image (with text)” is changed to the second image data object classified as the same format “image (with text)”. As shown on the first raw of the table, the value “1” of the first flag a is linked to the changing pattern. Accordingly, the length of switching time Δt is varied with levels of importance and interest assigned to the first and second image data objects. Furthermore, a display time rate of each image data object is adjusted in each segment T1, T2, . . . , of switching time Δt, since the fourth flag d is “1”. In addition, sound volumes reproduced in parallel with each image data object are stepwise changed within switching time Δt, since the fifth flag e is “1”. On the other hand, a display size and a format of each image data object are fixed, since both the second flag b and the third flag c are “0”.

Note that the flags may be allowed to be values other than “1” and “0”, when there are larger number of types of formats and changing patterns of display time rates. For example, when the first image data object of a format “image (with text)” is changed to the second image data object of the same format “image (with text)”, the format of each image data objects is changed in three steps “moving image, still image, and text”. When the first image data object of another format “image (without text)” is changed to the second image data object of the same format “image (without text)”, the format of each image data objects is changed in two steps “still image and text”.

As described above, different flags are prepared for different changing patterns in advance. This can help the switching method determination unit 17 easily select a type of switching. Finally, the switching method determination unit 17 changes values of display parameters to be provided to the output unit 19 continuously and stepwise within switching time Δt, in accordance with the selected type of switching.

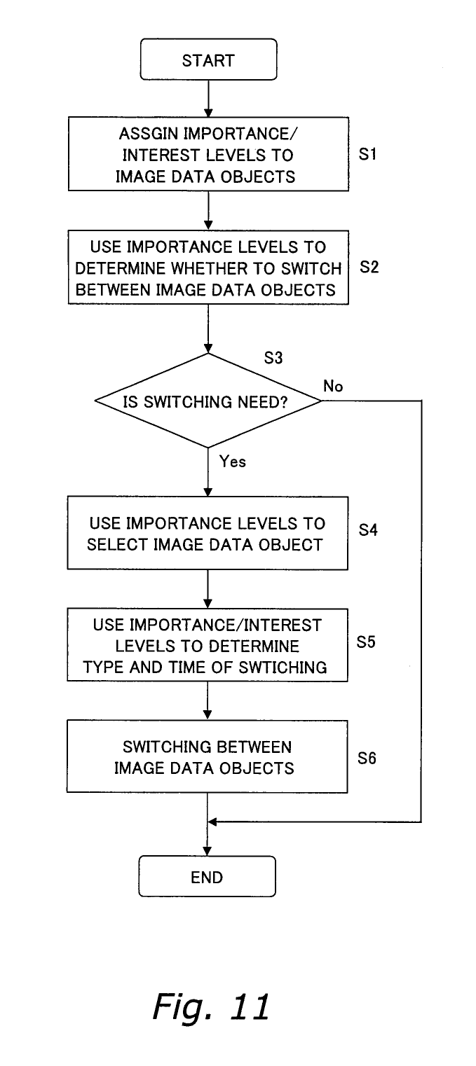

The image controller according to the above-described embodiment switches between image data objects in the following steps. FIG. 11 is the flow chart of the switching process.

Step S1: The importance level determination unit 11 uses the priority tables in which importance levels are arranged (cf. FIG. 3) to assign importance levels to each image data object stored in the image data storage unit 1. The interest level determination unit 13 uses the priority table in which interest levels are arranged (cf. FIG. 4) to assign interest levels to each of the image data objects.

Step S2: The image data selector unit 15 determines whether or not the image data object being outputted from the output unit 19 to the monitor at the present time is required to change to another image data object, on the basis of the importance levels determined in the step S1.

Step S3: If the image data selector unit 15 has found an image data object to which a higher level of importance is assigned than the image data object being outputted (the first image data object) in image data objects waiting for output, the image data selector unit 15 determines that the first image data object is to be changed, and proceeds the switching process to the step S4. Otherwise, the switching process is finished.

Step S4: The image data selector unit 15 selects an image data object to which the highest importance level is assigned from the image data objects waiting for output to the monitor as the second image data object.

Step S5: The switching method determination unit 17 uses importance and interest levels to determine a type of switching and switching time Δt for the switching from the first image data object to the second image data object.

Step S6: The output unit 19 changes the first image data object to the second image data object in accordance with the type of switching determined by the switching method determination unit 17.

In the above-described embodiment, the image data selector unit 15 selects the image data object to which the highest importance level is assigned from the image data objects waiting for output as the second image data object. Alternatively, the image data selector unit 15 may select the second image data object by comparing both of importance and interest levels, or using other types of priorities. When the output unit 19 can output more than one image data object to the monitor at the same time by using multi-windows, the image data selector unit 15 preferably selects the first and second image data objects as follows. First, importance levels to be assigned to image data objects during output to the monitor are determined on basis of priority tables. Next, the image data object of the lowest importance level is selected as an image data object whose display is to be suspended or stopped (or the first image data object). When the lowest importance level is assigned to two or more image data objects, interest levels to be assigned to the image data objects are further determined on the basis of priority tables, and the image data object to which the lowest interest level is assigned will be selected as the first image data object. On the other hand, when the highest importance level is assigned to two or more image data objects waiting for output, interest levels to be assigned to the image data objects are further determined on the basis of priority tables, and the image data object to which the highest interest level is assigned will be selected as the second image data object.

In the above-described embodiment, the switching method determination unit 17 uses levels of both interest and importance to determine switching time Δt from the first image data object to the second image data object. Alternatively, the switching method determination unit 17 may uses only either level of interest or importance, or other type of priorities (e.g., urgency and safety) to determine switching time Δt.

In the above-described embodiment, the state that the first image data object (of the title “foreign film”) A is displayed on the entire screen of the monitor is changed to the state that the second image data object (of the title “English conversation”) B is displayed on the entire screen, as shown in FIG. 8A. Alternatively, the method of switching image data objects according to the present invention can be applied to multi-windows as follows. Assume, for example, that the screen of the monitor is divided into four regions (windows), and four types of image data objects are displayed in different windows. When an image data object during display in a window (the first image data object) is to be changed to another image data object (the second image data object), the image controller reduces the display size of the first image data object in the window from 100% to 0% stepwise, and on the other hand, the display size of the second image data object in the window from 0% to 100% stepwise, within the switching time Δt.

### General Interpretation of Terms

In understanding the scope of the present invention, the term “configured” as used herein to describe a component, section or portion of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single portion or a plurality of portions. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. An image controller comprising a switching unit configured to
assign priorities to image data objects for display on the screen of a monitor;
compare the priorities between a first image data object during display on the screen and a second image data object to be next displayed thereon, and determine a length of switching time depending on the result of comparison; and
change each display form of the first image data object and the second image data object on the screen continuously or stepwise during the switching time.

2. An image controller according to the claim 1 further comprising a watching conditions acquisition unit configured to detect eyeball movements of a viewer, and monitor the gaze conditions of the viewer on each of the image data objects displayed on the screen on the basis of the eyeball movements,
the switching unit further configured to assign priorities to the image data objects displayed on the screen on the basis of the gaze conditions that the watching conditions acquisition unit has acquired.

3. An image controller according to the claim 2 wherein
the watching conditions acquisition unit is configured to measure a gaze time of the viewer on each of the image data objects displayed on the screen; and
the switching unit is configured to assign a higher priority to the image data object when the watching conditions acquisition unit has measured the longer gaze time thereon.

4. An image controller according to the claim 2 wherein
the watching conditions acquisition unit is configured to count the number of times that the viewer gazes on each of the image data objects displayed on the screen; and
the switching unit is configured to assign a higher priority to the image data object when the watching conditions acquisition unit has counted the larger number of times of gazing thereon.

5. An image controller according to the claim 1 further comprising a watching history acquisition unit configured to manage a history of image data objects displayed on the screen,
the switching unit further configured to assign priorities of the image data objects displayed on the screen, on the basis of the history that the watching history acquisition unit stores therein.

6. An image controller according to the claim 5 wherein
the watching history acquisition unit is configured to classify image data objects included in the history according to attribute thereof; and
the switching unit is configured to assign a higher priority to the image data object having the attribute into which a larger number of image data objects are classified in the history.

7. An image controller according to the claim 5 wherein
the watching history acquisition unit is configured to classify image data objects included in the history according to information sources thereof; and
the switching unit is configured to assign a higher priority to the image data object from the information source into which a larger number of image data objects are classified in the history.

8. An image controller according to the claim 1 further comprising a user-profile manager unit configured to accept information from a viewer,
the switching unit further configured to assign priorities of image data objects on the basis of the information from the viewer.

9. An image controller according to the claim 8 wherein the information from the viewer includes data indicating attributes of image data objects.

10. An image controller according to the claim 8 wherein the information from the viewer includes data indicating information sources of image data objects.

11. An image controller according to the claim 1 wherein the parameters indicating the display form of an image data object on the screen include one of a size, a position, a format, a display duration, transparency, and a level of layers thereof.

12. An image controller according to the claim 1 wherein the switching unit is configured to change the parameters indicating the display form as a non-linear function of time.

13. A method of image control comprising
assigning priorities to image data objects for display on the screen of a monitor;
comparing the priorities between a first image data object during display on the screen and a second image data object to be next displayed thereon, and determining a length of switching time depending on the result of comparison; and
changing each display form of the first image data object and the second image data object on the screen continuously or stepwise during the switching time.

14. A program product configured to cause a computer to function as a switching unit configured to
assign priorities to image data objects for display on the screen of a monitor;
compare the priorities between a first image data object during display on the screen and a second image data object to be next displayed thereon, and determine a length of switching time depending on the result of comparison; and
change each display form of the first image data object and the second image data object on the screen continuously or stepwise during the switching time.

15. A computer readable medium in which a program product is stored, the program product configured to cause a computer to function as a switching unit configured to
assign priorities to image data objects for display on the screen of a monitor;
compare the priorities between a first image data object during display on the screen and a second image data object to be next displayed thereon, and determine a length of switching time depending on the result of comparison; and
change each display form of the first image data object and the second image data object on the screen continuously or stepwise during the switching time.
